(19) United States
(12) Patent Application Publication
(10) Pub. No.: US 2026/0336023 A1
(43) Pub. Date: Oct. 29, 2026

(54) METHOD AND DEVICE FOR IMAGING A BEAM ON AN OBJECT, AND METHOD FOR INTRODUCING AN OPENING IN A WORKPIECE

(71) Applicant: LPKF LASER & ELECTRONICS SE, Garbsen (DE)

(72) Inventors: Andreas BOENKE, Hannover (DE); Roman OSTHOLT, Langenhagen (DE); Norbert AMBROSIUS, Garbsen (DE); Stefan QUACH, Minden (DE)

(21) Appl. No.: 19/121,434

(22) PCT Filed: Sep. 1, 2023
(86) PCT No.: PCT/EP2023/074035

§ 371 Date: Apr. 16, 2025

(30) Foreign Application Priority Data
Oct. 18, 2022 (DE) 10 2022 127 259.1

(51) Int. Cl. B23K 26/082; B23K 26/362

(52) U.S. Cl. CPC B23K 26/082; B23K 26/362

(57) ABSTRACT

A method includes deflecting a beam via a beam path at least twice with an angle, each time changing the beam path of the beam by an optical arrangement by an optical scanner system including at least two optical scanners, wherein the beam is not subject to refraction between each deflection; imaging the beam onto the object by imaging optics after the deflection; and placing a focus area of the beam on and/or in the object. A pivoting movement of a beam section emerging from the optical scanner system is generated, in which a pivot point of the beam section in the beam path lies in front of or in the imaging optics and the pivoting movement and/or at least one rotational movement about the pivot point causes a movement of the focus area in at least one spatial direction perpendicular to an optical axis of the imaging optics.

### CROSS REFERENCE TO RELATED APPLICATIONS

This application is a U.S. National Phase application under 35 U.S.C. § 371 of International Application No. PCT/EP2023/074035, filed on Sep. 1, 2023, and claims benefit to German Patent Application No. DE 10 2022 127 259.1, filed on Oct. 18, 2022. The International Application was published in German on Apr. 25, 2024 as WO 2024/083393 A1 under PCT Article 21(2).

### FIELD

The invention relates to a method and a device for imaging at least one beam onto an object. Furthermore, the invention relates to a method for introducing at least one opening into the object formed as a workpiece from a transparent material by means of the aforementioned method.

### BACKGROUND

Due to its optical, electrical, chemical and mechanical properties, glass is highly suitable for replacing silicon, for example, not only as a carrier but also as a directly structured bulk material at comparatively low cost, opening up a wide range of possible applications. These range from micro- and nanoelectronics to microelectromechanical systems (MEMS) and applications in the field of microfluidics to use in the packaging of systems. However, an important prerequisite for this is the availability of a glass processing method by means of which the production of precise structures of very small dimensions in the glass and thus micro-processing of the glass is possible with a preferably high degree of freedom of form of the structures in conjunction with short processing times.

In principle, a wide range of glass processing methods are already known from the state of the art, including abrasive cutting, etching or laser ablation methods for processing the glass. However, these processes have the disadvantage of sometimes long processing times with little freedom of form. In some cases, the aforementioned processes also introduce undesirable defects into the glass, for example in the form of chipping, microcracks or thermally induced stresses.

Another process known from the prior art which does not have these disadvantages is the micromachining of the glass by means of laser-induced deep etching. One such process has become known as laser induced deep etching (LIDE). The LIDE process makes it possible to create extremely precise structures with extremely short processing times, thus creating the prerequisites for the increased use of glass as a material in the applications mentioned above.

The LIDE process stands in contrast to a process known as selective laser-induced etching, also known as in volume selective laser induced etching (ISLE), which is suitable for creating structures from and in transparent materials. For this purpose, laser radiation is focused almost point-like inside a transparent material such as glass, whereby the material is structurally and/or chemically changed in a small volume of just a few cubic micrometers. The modified volumes can then be etched at an etching rate that is ten orders of magnitude higher than that of unmodified material. Due to the small volumes that have been changed due to the point-like focusing of the laser beam, an extremely high number of pulse sequences is necessary for structuring. However, these in turn lead to long processing times.

In contrast, in laser-induced deep etching, known for example from WO 2014/161 534 A2 and WO 2016/041 544 A1, a transparent material, in particular glass, is modified by means of a laser pulse or a pulse sequence over an elongated area along the beam axis, so that the modification is etched anisotropically again in a subsequent wet chemical etching bath. The modification is often carried out over the entire thickness of the transparent material, for example over the entire thickness of a glass plate.

WO 2021/239 302 A1 also discloses a similar method for introducing a recess, for example a blind hole, into a transparent material by means of laser-induced deep etching, whereby the modification of the material also takes place over the entire longitudinal area of the recess to be formed. The modification is achieved by the fact that the focal area of the laser steel, in contrast to a point-shaped design, has a spatial expansion in the beam direction and thus a beam shaping. This spatial expansion or extension of the focal area of the laser beam in the beam direction means that a sufficiently high intensity can be coupled into the transparent material to modify an area over its length.

The aforementioned embodiments of laser-induced deep etching, but in particular WO 2021/239 302 A1, also describe the modification of several areas aligned parallel to each other, partially overlapping, so that, for example, larger, flat structures can also be formed in a transparent material. For this purpose, a laser head, which emits the laser beam causing the modification, is regularly moved along at least one linear axis and at least one laser pulse is emitted at the areas to be modified during the process. Despite the short processing times that can already be provided by laser-induced deep etching, this design disadvantageously limits the achievable shorter processing times, since accelerations and speeds of linear axes are comparatively limited, in particular due to high masses.

In this context, however, it is already known from the state of the art to deflect a laser beam using an optical scanner system, for example, by means of at least one galvanometer scanner, in order to increase the area that can be covered by a laser beam within a short period of time.

However, the use of scanner systems for deflecting laser beams that have the aforementioned beam shaping proves to be problematic, especially in combination with standard optics typically used for imaging the laser beam onto the material. This is because it causes a fault of the beam shaping, preventing the extended focal range from being ensured.

US 2014/0 008 549 A1 discloses a method and a device for generating a volumetric image of a sample with an extended depth of field using laser scan imaging. For this purpose, a laser beam with an extended focus range in the area of the image to be excluded is used, which is deflected in two spatial directions via two scanner mirrors. To provide the extended focus area on the sample, a Bessel-like, non-diffracting beam is generated from the laser beam initially emitted by a laser source using an axicon. Before each deflection, this is transformed by one of the two scanner mirrors via a collecting lens into a ring beam with the focus on the scanner mirror in order to avoid distortions of the laser beam during deflection. After each deflection, the steel is transformed back into a non-diffracting beam via an achromatic lens. To provide the beam with an extended focal range for recording the sample, this is focused again by a converging lens to form the ring beam, whereby the focus is placed on the rear focal plane of the lens system imaging the beam onto the sample. The imaging lens system is used to repeatedly transform the beam into a non-diffractive, Bessel-like beam, which has an extended focal range at the sample. However, the complex optical setup chosen in this case disadvantageously generates superimposed imaging errors that are imparted to the beam due to the large number of optical elements. In addition, the structure chosen for a microscopy system is largely unsuitable for an application in the field of laser processing due to the optical elements required in some cases.

WO 2010/069 987 A1 provides a comparable method and a device for dynamically shifting a light beam relative to an optical system focusing the light beam in the context of confocal microscopy. In order to scan an object with the focused light beam in a two-dimensional scanning area, the light beam is deflected in two different directions relative to the optical axis of the optics, whereby a respective deflection in one direction is realized via two independently moving deflection mirrors. This makes it possible to adjust the position of the pivot point of the light beam deflected by the deflecting mirrors forming a mirror deflection system in the longitudinal direction of the optical axis. It is intended that the pivot point of the light beam is fixed at the location of an image of a pupil of an optical system that is connected to the mirror deflection system and focuses the light beam. For this purpose, the deflection mirrors are arranged around this imaging location. The pivot point of a beam section of the light beam emerging from the mirror deflection system lies within the mirror deflection system.

DE 10 2020 131 405 A1 also describes a device for material processing, in particular for producing perforations, lines, free-form contours or the like using a laser beam source. In addition to the laser beam source, the device has a mirror deflection system that deflects the laser beam as well as a focusing lens. The mirror deflection system provides a deflection of the laser beam relative to the optical axis in two different spatial directions, whereby a deflection in one direction is realized via one deflection mirror each. For this purpose, the two deflecting mirrors are designed to move independently of each other and their rotation axes are aligned at right angles to each other. Thus, the pivot point of the laser beam section emerging from the mirror deflection system lies on the rear deflection mirror in the beam path. In addition, a diffractive optical element “DOE” is arranged in the beam path of the laser beam between the mirror deflection system and the focusing lens for splitting the beam path into two or more beam paths in order to generate a pattern of processing points on the material to be processed and/or to perform positioning of the processing point or processing points on the material. By positioning the “DOE” in the beam path of the laser after the mirror deflection system and before the focusing lens, the resulting short beam length means that the widening of the beam spacing of the individual beam bundles can be kept together to such an extent that even if the primary laser beam is deflected within the area that the mirror deflection system allows it to cover, all of the individual beam bundles of the laser beam multiplied by the “DOE” can still be directed onto the focusing lens and thus focused accordingly.

Similarly, EP 3 106 943 B1 also describes a device for material processing by means of a laser beam, whereby the device has a mirror deflection system for deflecting the laser beam. The mirror deflection system is again designed in such a way that a deflection of the laser beam relative to the optical axis is provided in two different spatial directions via the mirror deflection system. In this case, a respective deflection in one direction is realized via a deflection mirror each, whereby the two deflection mirrors are designed to be movable independently of each other and their rotation axes are aligned at right angles to each other. This means that the pivot point of the beam section of the laser beam emerging from the mirror deflection system lies on the rear deflection mirror in the beam path. In order to enable integration of the mirror deflection system into the path control of a machine tool due to the non-cardanic arrangement of the deflection mirrors, the device provides a control module, via which the target data of two cardanic, virtual swivel axes transferred by the path control are converted into a first and second, real target axis swivel angle of the deflection mirrors.

WO 2014/161 534 A2 also provides a method and a device for producing a plurality of recesses in a substrate, which can be used in particular as an interposer. The process involves directing a laser radiation onto the surface of the substrate, whereby the exposure time of the laser radiation is deliberately kept very short. This simply results in a modification of the substrate in a concentric pattern around the beam axis of the laser beam. However, the effect of the laser radiation does not create any recesses in the substrate material itself. To achieve this, the laser radiation is first directed through a transmissive medium that has an intensity-dependent refractive index that is higher than that of air. The laser radiation then hits the substrate. The intensity of the laser beam varies during the individual pulse. It rises to a maximum and then falls again. This change in intensity means that the refractive index of the medium also changes. Due to this change in the refractive index, the focus point of the laser radiation moves along the beam axis between the outer surfaces of the substrate. This allows the desired modification along the beam axis to be achieved without having to realign the laser processing head in the Z-axis. The modifications of the substrate produced in this way can then be etched in hydrofluoric acid at a significantly higher etching rate than unmodified areas.

### SUMMARY

In an embodiment, the present disclosure provides method for imaging at least one beam of electromagnetic radiation onto an object. The method includes: deflecting the at least one beam via a beam path of the at least one beam at least twice with a predetermined and/or predeterminable variable angle, each time changing the beam path of the at least one beam by an optical arrangement by means of an optical scanner system of the optical arrangement including at least two optical scanners, wherein the at least one beam is not subject to refraction between each respective deflection; imaging the at least one beam onto the object by means of imaging optics after the at least one beam's deflection; and placing a focus area of the at least one beam on and/or in the object by means of the imaging optics. The at least one pivoting movement of a beam section of the at least one beam emerging from the optical scanner system is generated by means of the optical scanner system, in which a pivot point of the beam section in the beam path lies in front of or in the imaging optics and the pivoting movement and/or at least one rotational movement about the pivot point causes a movement of the focus area in at least one spatial direction perpendicular to an optical axis of the imaging optics.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a development of a device according to an embodiment of the present invention;

FIG. 2a illustrates a further embodiment of a method according to the present invention;

FIG. 2b illustrates a further embodiment of a method according to the present invention;

FIG. 3a illustrates a further embodiment of a method according to the present invention; and

FIG. 3b illustrates a further embodiment of a method according to the present invention.

### DETAILED DESCRIPTION

Against this background, embodiments of the present invention can provide a method and a device of the type mentioned at the outset, which have an optical structure adapted for use in a laser processing application and, moreover, simplified. For example, in an embodiment of the present invention, a method and a device for imaging at least one beam onto an object is provided, wherein the beam is deflected along its beam path at least twice by an optical arrangement using at least two optical scanners, changing the beam path of the beam, and the beam is also imaged onto the object after its deflection by means of imaging optics, and by imaging by means of the imaging optics, a focus area of the beam is placed on and/or in the object.

According to an embodiment of the invention, a method is provided for imaging at least one beam of electromagnetic radiation, and in a particular embodiment a laser beam of laser radiation, onto an object. Such a beam, in a particular embodiment a pulsed beam, would preferably first be emitted by a beam source, in particular a laser source, of the optical arrangement.

Here, the beam emitted in a particular embodiment is deflected via its beam path through an optical arrangement by means of an optical scanner system of the optical arrangement, changing the beam path or a propagation direction of the beam. For this purpose, the scanner system has at least two optical scanners, via which the beam is deflected at least twice with a predetermined and/or predefinable, variable angle.

The beam or radiation is not subject to any further refraction before and/or between a respective deflection. Thus, at least between each deflection, the beam does not pass through any further optical element that particularly refracts the beam, such as a converging lens, which significantly simplifies the optical structure and avoids undesirable imaging errors. However, any fault to any existing beam formation caused by this when the beam is deflected may require correction.

Thus, according to an embodiment of the invention, the beam is imaged onto the object by means of imaging optics after it has been deflected, whereby imaging by means of the imaging optics places a focus area of the beam onto and/or into the object. In accordance with the embodiment, it is further provided that the scanner system is used to generate at least one pivoting movement of a beam section of the beam emerging from the scanner system, in which the pivot point or center of rotation of the beam section lies in the beam path in front of or in the imaging optics. The pivoting movement and/or at least one rotational movement around the pivot point causes the focus area to move in at least one spatial direction perpendicular to the optical axis of the imaging optics. By placing the pivot point of the beam section in front of and/or in the imaging optics, undesirable imaging errors introduced into the beam by deflection are advantageously avoided. This is especially true without the use of special imaging optics to avoid such undesirable imaging errors. On the other hand, standard optics normally used for imaging the beam onto the object can be used as imaging optics.

Furthermore, according to an embodiment of the invention, a method is provided for introducing at least one opening, and in a particular embodiment a recess and/or an opening, into the object formed as a workpiece, preferably as a substrate, made of a transparent material, in a particular embodiment being glass. In this process, using the method described above according to the embodiment for imaging the beam, a modification of the material of the workpiece is generated at least in the focus area of the beam, but especially exclusively in the focus area of the beam. This occurs without the material being removed as a result of the effect of the radiation from the beam, so that the opening is subsequently created by the effect of an etching medium through anisotropic removal of the material in the respective area of the modification in the workpiece. The material is therefore removed solely as a result of the corrosive effect of the corrosive medium and not as a direct result of the effect of the jet or the radiation of the jet. Although the etching rate of the modification or modifications is several orders of magnitude higher than that of an unmodified material, the workpiece can additionally be provided with a mask, in particular an etching mask, preferably made of a structured photoresist, in which the areas to be etched are exposed.

A respective modification would preferably be generated by at least one pulse of the beam, whereby to generate several modifications, e.g. located at different positions on the workpiece, the beam or the focal area of the beam is moved between the pulses of the beam by deflecting it over the workpiece. In this way, non-contiguous or contiguous, even overlapping modifications can be created in the workpiece, which are removed during the subsequent action of the etching medium and form at least one opening in the workpiece. By creating several contiguous modifications, it is thus possible to form structures with a high degree of freedom of form in the workpiece that are composed of a large number of individual openings.

Moving the focus area by deflecting it via the optical scanners, which is used to create a large number of modifications, also significantly reduces processing times while maintaining a high degree of freedom of form, particularly in comparison with a standard LIDE process.

The range per spatial direction that can be covered by the deflection of the beam and thus the movement of the focal area, in which the modifications could consequently also be generated, in particular embodiments without superimposing a further movement, can be up to plus/minus ten millimeters around a central axis or a center point, for example. This is achieved with an extremely low positioning error of the focus area and therefore the modifications of less than ten micrometers.

In an advantageous embodiment of the invention, a respective rotational movement of the beam section about—exclusively—one axis of rotation of the pivot point and thus a respective linear movement of the focus area in a—single—spatial direction is carried out via two interacting rotational movements of two optical scanners about their two mutually parallel axes of rotation, which deflect the beam in the beam path. The two scanners form a scanner pair. By using two scanners with axes of rotation aligned parallel to each other to move the focus area of the beam in a single spatial direction, undesirable imaging errors of the beam and in particular of the focus area, which would occur if only one scanner were used, can be profitably minimized or even avoided.

An embodiment of the invention is also extremely advantageous if two rotational movements of the beam section about, in particular, perpendicular axes of rotation of the pivot point are superimposed on the linear movement of the focus area in two spatial directions. This would allow the focal area of the beam or the beam hitting the object or workpiece to be moved not only along a line but also two-dimensionally over a surface. To carry out the two rotational movements of the beam section around the pivot point, the beam would be deflected over two rotational axes for each rotational movement and thus over a total of four rotational axes to form two groups of two rotational axes, with the rotational axes of the two groups being aligned perpendicular to each other. The axes of rotation would be provided accordingly by the optical scanners, whereby a group of two axes of rotation would therefore be formed via a pair of scanners.

Furthermore, in a promising embodiment of the invention, it is provided that the two rotational movements of a scanner pair, which cause a rotational movement of the beam section about—exclusively—one axis of rotation of the pivot point, interact and deflect the beam in the beam path, are designed asynchronously. This asynchronous movement advantageously allows the pivoting movement of the beam around at least one scanner of the scanner pair, specifically the second or rear scanner of the scanner pair in the beam path, to be achieved. At least one of the variables absolute angle, angular velocity and/or angular acceleration of the scanners, and in a particular embodiment of a deflection element of the scanners, should differ from one another.

It should also be mentioned that, in principle, there is the possibility that the beam formed in the context of at least one of the methods generally, and especially in the focus region of the beam, has a Gaussian focus at and/or in the object or workpiece. This would therefore correspond to a design without beam shaping of the beam and thus an extended focus range. Any imaging errors that may occur could nevertheless be avoided.

In a preferred embodiment of the invention, it is provided that the beam undergoes beam shaping through a beam-shaping optics during its path through the optical arrangement, thereby forming an extended focal range in the direction of the beam path at and/or in the object. This extended focal range is imaged over at least part of a dimension of the object formed in the direction of the beam path. As already mentioned at the beginning, the extended focus range makes it possible to significantly reduce the processing times of the object, which in a particular embodiment is designed as a workpiece, within the scope of a LIDE process compared to a point-shaped focus, thus increasing the throughput.

The beam shaping can be performed by beam shaping optics, which can be an axicon, a diffractive optical element (DOE) or a spatial modulator for light, also known as a spatial light modulator (SLM). This would allow the beam to be designed as a Bessel-like beam in a particular embodiment. In a widely preferred embodiment, however, the beam shaping would be carried out by imposing a spherical aberration, which also results in an extended, in particular cigar-shaped, focus area of the beam. For such beam shaping embodiment, the beam shaping element should preferably be designed as a quartz plate, particularly a plane-parallel one.

In a further advantageous embodiment of the invention, the imprinting of the beam shaping by means of the beam shaping optics also takes place before the beam enters the optical scanner system of the arrangement. In this way, the formation of imaging errors can be avoided by shaping a deflected beam that strikes the beam shaping element at an angle.

A practical embodiment of the invention is further based on the fact that a respective focus area of the beam, whose beam path changes due to the optical arrangement due to the deflection, is imaged by the imaging optics onto a—single, in particular common—focus plane on which the respective focus area lies or from which the respective focus area extends into the object. The focus area, which thus always lies on the focal plane or extends from the focal plane, can advantageously ensure an intensity of the beam in the focus area that acts on the object and, in a particular embodiment, on the material of the workpiece. This also results in the uniform or similar creation of several modifications in the material of the workpiece. For this purpose, the imaging optics should, in a preferred embodiment, be designed as at least one f-theta lens system.

An advantageous embodiment of the invention further provides that the imaging of each focus region is carried out telecentrically by the imaging optics. In this way, the focus area of the beam would always be aligned parallel to the optical axis of the imaging optics, which would allow modifications to be created in the workpiece that are always aligned in the same direction and thus do not differ in their angular orientation in the workpiece. This is achieved by aligning the object or workpiece accordingly, in a particular embodiment perpendicular to the surface of the object or workpiece. For this purpose, the imaging optics should, in a preferred embodiment, be designed as at least one telecentric f-theta lens system.

Likewise, an advantageous embodiment of the invention is described in that the linear movement of the focus area in at least one spatial direction is superimposed with at least one additional movement, in particular a linear movement, of a traversing axis. In this case, the traversing axis is part of a device, with at least one part of the optical arrangement associated with the device being arranged on the traversing axis. The traversing axis is designed in a particular embodiment as a linear axis. By combining the movement of the focus area by deflecting the beam via one or two scanner pairs in a particular embodiment with the additional movement of at least one travel axis, workpieces can also be processed whose dimensions exceed the maximum possible deflection of the beams or the resulting possible movement section of the focus area, and thus the workpiece can preferably be processed over its entire extent with very high processing speeds and thus short processing times. In addition, modifications can be created in the workpiece which individually and/or contiguously follow a virtually arbitrary trajectory, e. g. in the form of a spline. The respective possible directions of movement of the focus area and the traversing axis do not have to be parallel and/or perpendicular to each other. On the other hand, it is conceivable to align it at virtually any angle, for example an angle of 45 degrees.

In particular in connection with the above development, but also in general, an embodiment of the invention provides the additional movement of the travel axis as at least partially corrected and/or at least partially compensated by the superposition of the—linear—movement of the focus area in at least one spatial direction with the at least one additional—linear—movement of the travel axis. In the case of aligned movement directions of the focus area and the travel axis, the movement of the focus area could thus be superimposed, particularly redundantly, with the movement of the travel axis. This would, for example, increase the resolution of the positioning of modifications in relation to the resolution provided by the travel axis itself in the workpiece. In addition, the movement of the traversing axis can also be fully compensated by the movement of the focus area. This is the case, for example, when several modifications are to be made in the workpiece in the exact same position or in the same position but with an offset, e.g. transverse to the direction of movement of the travel axis. A very high degree of freedom of form in the structures created in the workpiece can therefore be guaranteed with outstanding precision.

Furthermore, according to an embodiment of the invention, a device with an optical arrangement is also envisaged, in particular for carrying out at least one of the methods explained above. The optical arrangement of the device has a beam source, in a particular embodiment a laser source, for emitting a beam of electromagnetic radiation, in particular a laser beam of laser radiation, and an optical scanner system. For its part, the scanner system is designed with at least two optical scanners, each with at least one rotatable deflection element for deflecting the beam. In this context, it should be noted that no other element, in a particular embodiment an optically refracting element, is arranged in the beam path between the scanners. Furthermore, the optical arrangement includes at least one imaging optic, through which the beam can be imaged onto an object, and by imaging via the imaging optic, a focus region of the beam can be positioned onto and/or into the object. According to an embodiment of the invention, two scanners form a scanner pair, whereby the axes of rotation of the scanners belonging to a respective scanner pair are aligned parallel to each other. The optical arrangement has at least one pair of scanners or at least two, in a preferred embodiment only two, pairs of scanners. It should be noted, however, that the axes of rotation or the groups of axes of rotation of the scanners of the different scanner pairs are aligned perpendicular to each other. By means of the device according to an embodiment of the invention, at least some of the methods according to an embodiment of the invention can be advantageously carried out, with a significantly simplified optical structure of the optical arrangement. In this way, undesirable imaging errors can be avoided and at the same time faults in any existing beam formation caused by deflection of the beam can be corrected by placing a pivot point or turning point of a beam section emerging from the scanner system in the beam path in front of or in the imaging optics via the scanner system. In addition to the optical arrangement, the device would also have at least one traversing axis on which at least part of the optical arrangement is arranged.

In a particularly advantageous embodiment of the invention, the optical arrangement also has beam shaping optics, by means of which a beam shaping can be imprinted on the beam. As previously explained, the beam-shaping optics is, for example, implemented as an axicon, a diffractive optical element (DOE), a spatial light modulator (SLM), or as a particularly plane-parallel quartz plate, and/or is preferably arranged after the beam source and before the optical scanner system.

The invention permits various embodiments. To further clarify their basic principle, some of them are shown in the drawings and are described below.

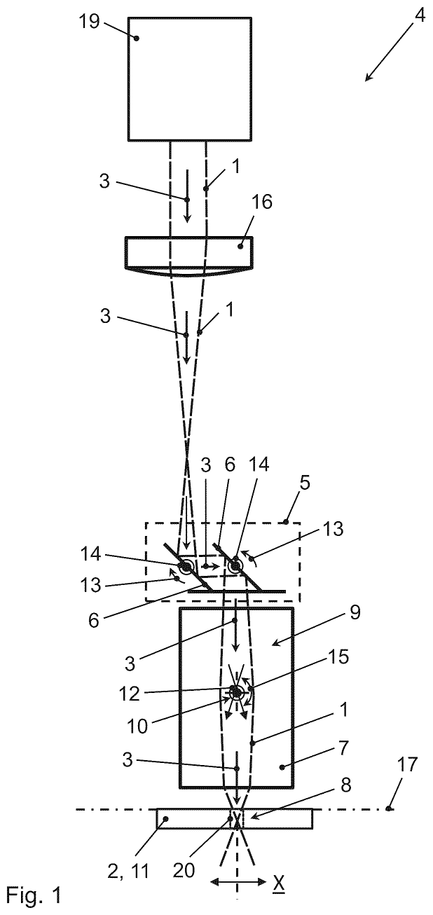

FIG. 1 shows a further development of an optical arrangement 4, wherein the optical arrangement 4 has the beam source 19 for emitting the beam 1, the beam shaping optics 16, the scanner system 5 comprising the two optical scanners 6, each with a rotatable deflection element, here a mirror, for deflecting the beam 1, and the imaging optics 7.

After the beam 1 exits from the beam source 19, a beam shaping is imposed on the beam 1 by means of the beam shaping optics 16 following the beam source 19 in the beam path 3.

The beam 1 is then deflected twice by the optical scanner system 5, which follows the beam-shaping optics 16 in the beam path 3, each time at a predetermined, variable angle, altering the beam path 3 of the beam 1. This allows the beam to be imaged at different positions on the workpiece 11, generating a modification 20 of the material of the workpiece 11 in the focus region 8 of the beam 1, with the focus region 8 of the beam 1 being positioned into the workpiece 11 in the further development of FIG. 1. The beam 1 is deflected by the two scanners 6 of the scanner system 5.

In order to avoid a fault of the beam shaping imposed on the beam 1 via the beam shaping optics 16, a pivoting movement of the beam section 9 of the beam 1 emerging from the scanner system 5 is generated by means of the scanner system 5 and in particular by means of the scanner 6 following the first scanner 6 in the beam path 3 and arranged in front of the imaging optics 7, in which the rotation or pivot point 10 of this beam section 9 lies in the beam path 3 in the imaging optics 7. The pivoting movement thus results in the rotational movement 15 of the beam 1 around the pivot point 10, which, in this development, in turn causes a movement of the focus region 8 in the spatial direction X, perpendicular to the optical axis of the imaging optics 7.

In this context, it should be briefly noted that FIG. 1 shows the beam 1 in a very simplified form in its beam profile, whereby only one beam path 3 of the beam 1 is shown.

The special feature of the deflection of the beam 1 via the scanner system 5, which was only briefly outlined above, is that the rotational movement 15 of the beam section 9 about the axis of rotation 12 of the pivot point 10 and thus also the linear movement of the focus area 8 in the spatial direction X is carried out via two interacting rotational movements 13 of the scanners 6 about their two mutually parallel rotational axes 14, which deflect the beam 1 in the beam path 3. The two scanners 6 form a scanner pair, whereby the rotational movements 13 of the scanners 6 of the scanner pair are asynchronous.

By imposing the beam shaping and imaging the beam 1 with the applied beam shaping through the imaging optics 7, an extended focal region 8 in the direction of the beam path 3 is imaged onto and/or into the workpiece 11, which in this development extends over the entire dimension formed in the direction of the beam path 3, here the thickness of the workpiece 11. The extended focus area 8 thus causes a modification 20 of the material of the workpiece 11 over the entire thickness of the workpiece 11, so that an opening, in this case a perforation of the workpiece 11, is produced by an etching step following the modification 20.

In order to be able to ensure a substantially constant intensity of the beam 1 in the focus area 8 acting on the material of the workpiece 11 in the case of several modifications 20 to be produced at different positions in the workpiece 11, the respective focus area 8 producing a modification 20 of the beam 1 deflected for positioning and thus changing in its beam path 3 is telecentrically imaged by the imaging optics 7 onto a single focus plane 17, from which the respective focus area 8 extends into the workpiece 11.

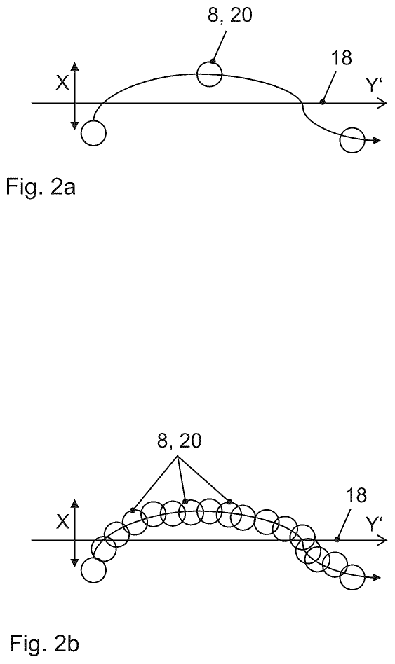

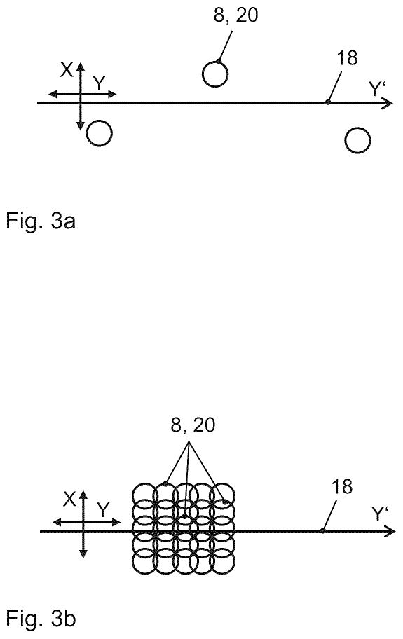

FIGS. 2a and 2b as well as 3a and 3b also show further embodiments of the methods according to the invention. These figures show that the movement of the focus area 8 in the spatial directions X, Y is superimposed with an additional movement of the traversing axis 18 in the direction of movement Y′, which coincides with the spatial direction Y. This allows modifications 20 to be created in the focal areas 8 in the workpiece 11 shown in more detail in FIG. 1, which are isolated as in FIGS. 2a and 3a or formed as in FIGS. 2b and 3b.

It is possible for the focus areas 8 and thus the modifications 20 to follow a virtually arbitrary trajectory, here in the form of a spline, as shown in FIGS. 2a and 2b, so that depending on the pulse sequence of the beam 1 shown in FIG. 1, as in FIG. 2a, individual openings or, as in FIG. 2b, cuts are generated by an overlap of several openings in the workpiece 11. In the further development of FIGS. 2a and 2b, the movement of the focus area 8 in only the spatial direction X is superimposed with the movement of the travel axis 18 in its direction of movement Y′, wherein the spatial direction X and the direction of movement Y′ are perpendicular to one another.

By superimposing the movement of the focus region 8 in the spatial directions X and Y with the additional movement of the travel axis 18 in its movement direction Y′, the additional movement of the travel axis 18 can also be at least partially corrected and/or at least partially compensated.

Thus, as shown in FIG. 3a, the movement of the focus area 8 can be superimposed, in particular in redundancy, on the movement of the travel axis 18 and thus, for example, a resolution of the positioning of the modifications 20 can be increased compared to the resolution provided by the travel axis 18 itself in the workpiece 11.

In addition, the movement of the traversing axis 18 can also be fully compensated by the movement of the focus area 8. This is particularly the case if, as in FIG. 3b, several modifications 20 are produced in the same position in the direction of movement Y′ of the traversing axis 18, but with an offset transverse to the direction of movement Y′ in the spatial direction X in the workpiece 11.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SYMBOLS

| | |
|---|---|
| 1 | Beam |
| 2 | Object |
| 3 | Beam path |
| 4 | optical arrangement |
| 5 | Scanner system |
| 6 | Scanner |
| 7 | Imaging optics |
| 8 | Focus area |
| 9 | Beam section |
| 10 | Pivot point |
| 11 | Workpiece |
| 12 | Rotary axis |
| 13 | Rotational movement |
| 14 | Rotation axis |
| 15 | Rotational movement |
| 16 | Beam shaping optics |
| 17 | Focus level |
| 18 | Traversing axis |
| 19 | Beam source |
| 20 | Modification |
| X, Y | Spatial direction |
| Y′ | Direction of movement |

1: A method for imaging at least one beam of electromagnetic radiation onto an object, comprising:
deflecting the at least one beam via a beam path of the at least one beam at least twice with a predetermined and/or predeterminable variable angle, each time changing the beam path of the at least one beam by an optical arrangement by means of an optical scanner system of the optical arrangement comprising at least two optical scanners wherein the at least one beam is not subject to refraction between each respective deflection;
imaging the at least one beam onto the object by means of imaging optics after the at least one beam's deflection; and
placing a focus area of the at least one beam on and/or in the object by means of the imaging optics, wherein at least one pivoting movement of a beam section of the at least one beam emerging from the optical scanner system is generated by means of the optical scanner system, in which a pivot point of the beam section in the beam path lies in front of or in the imaging optics and the pivoting movement and/or at least one rotational movement about the pivot point causes a movement of the focus area in at least one spatial direction perpendicular to an optical axis of the imaging optics.

2: The method according to claim 1, wherein at least one opening is made in the object, wherein the object is formed as a workpiece comprising a transparent material, wherein a modification of the material of the workpiece is produced at least in the focus area of the at least one beam, without any removal of the transparent material occurring as a result of an action of the at least one beam, wherein the opening is subsequently produced by an action of an etching medium through an anisotropic removal of the transparent material in a respective region of the modification in the workpiece.

3: The method according to claim 1, wherein a respective rotational movement of the beam section about a rotation axis of the pivot point and thus a respective linear movement of the focus area in the at least one spatial direction is carried out via two interacting rotational movements of the at least two optical scanners forming a scanner pair about their two mutually parallel rotation axes which deflect the at least one beam in the beam path.

4: The method according to claim 1, wherein two rotational movements of the beam section around two rotational axes of the pivot point are superimposed to achieve linear movement of the focus area in two spatial directions of the at least one spatial direction.

5: The method according to claim 3, wherein the interacting rotational movements of the at least two optical scanners of the scanner pair are configured to be asynchronous.

6: The method according to claim 1, wherein the at least one beam is shaped through its beam path by the optical arrangement using a beam-shaping optics, so that the focus area extended in a direction of the beam path is imaged at and/or within the object, which extends over at least part of a dimension of the object formed in the direction of the beam path.

7: The method according to claim 1, wherein imprinting of a beam shaping by means of beam shaping optics takes place before an entry of the at least one beam into the optical scanner system.

8: The method according to claim 1, wherein a respective focus area of the at least one beam changing in its beam path through the optical arrangement due to the deflection is imaged by the imaging optics onto a focal plane on which the respective focus area lies or from which the respective focus area extends.

9: The method according to claim 1, wherein the imaging of the respective focus area by the imaging optics is carried out telecentrically.

10: The method according to claim 1, wherein the movement of the focus area in the at least one spatial direction is superimposed with at least one additional movement of a travel axis associated with a device, on which at least part of the optical arrangement associated with the device is arranged.

11: The method according to claim 10, wherein the additional movement of the travel axis is at least partially corrected and/or at least partially compensated by a superposition of the movement of the focus area in the at least one spatial direction with the at least one additional movement of the travel axis.

12: An apparatus comprising the optical arrangement for carrying out the method according to claim 1, wherein the optical arrangement further comprises a beam source for emitting the at least one beam of the electromagnetic radiation, the scanner system comprising the least two optical scanners, each with at least one rotatable deflection element for deflecting the at least one beam, and the imaging optics, through which the at least one beam can be imaged onto the object, and configured to, by imaging with the imaging optics, place the focus area of the at least one beam onto and/or into the object, wherein no further optical element is arranged in the beam path between the at least two optical scanners, wherein every two scanners form the scanner pair, with their rotational axes aligned parallel to each other, and wherein the optical arrangement further comprises at least one scanner pair or at least two scanner pairs, with the rotational axes of the at least one scanner pair or the at least two scanner pairs are oriented perpendicular to each other.

13: A device according to claim 12, wherein the optical arrangement further comprises a beam-forming optics by means of which a beam shape can be imposed on the at least one beam.
